(19) United States
(12) Patent Application Publication
(10) Pub. No.: US 2019/0286295 A1
(43) Pub. Date: Sep. 19, 2019

(54) FINGERPRINT OPERATION PROMPTING METHOD, DISPLAY PANEL AND DISPLAY DEVICE

(71) Applicant: KunShan Go-Visionox Opto-Electronics Co., Ltd., Kunshan (CN)

(72) Inventors: Fang YU, Kunshan (CN); Xinquan CHEN, Kunshan (CN); Jinquan ZHANG, Kunshan (CN); Caifeng GONG, Kunshan (CN)

(73) Assignee: KunShan Go-Visionox Opto-Electronics Co., Ltd., Kunshan (CN)

(21) Appl. No.: 16/427,764

(22) Filed: May 31, 2019

Related U.S. Application Data
(63) Continuation of application No. PCT/CN2018/102447, filed on Aug. 27, 2018.

(30) Foreign Application Priority Data
Dec. 29, 2017 (CN) 201711481125.0

(51) Int. Cl. G06F 3/0488; G06F 3/041; G06K 9/00

(52) U.S. Cl. CPC G06F 3/0488; G06K 9/00919; G06K 9/00006; G06F 3/0416

(57) ABSTRACT

A fingerprint operation prompting method includes detecting whether a display device receives a fingerprint recognition instruction; and dynamically displaying a first image for prompting a fingerprint operation in a preset target area when the fingerprint recognition instruction implemented for the display device is detected. The preset target area is located in a display area of the display device.

### CROSS-REFERENCE TO RELATED APPLICATION

This application claims priority to Chinese Patent Application No. 201711481125.0, filed on Dec. 29, 2017, with a title “FINGERPRINT OPERATION PROMPTING METHOD, DISPLAY PANEL AND DISPLAY DEVICE”, the entire contents of which are hereby incorporated by reference.

### TECHNICAL FIELD

The application relates to a display technology field, and particularly to a fingerprint operation prompting method, a display panel, and a display device.

### BACKGROUND TECHNOLOGY

A display device with under screen fingerprints inconvenient for a user to find a corresponding fingerprint recognition area for a fingerprint recognition operation in time, owing to a fingerprint recognition module hidden under the screen. Although a normally on static graphic can be arranged in the fingerprint recognition area located in the display area for prompting, since the same static graphic is displayed for a long time, a ghost shadow is left in the fingerprint recognition area even when no prompting is required after the fingerprint recognition operation ends or when pictures are normally displayed on an entire screen, thereby affecting a display quality of the display device.

### SUMMARY

The embodiment of the application provides a fingerprint operation prompting method, a display panel, and a display device, to solve the problem that a ghost shadow is present in the fingerprint recognition area owing to displaying the same static graphic for a long time on the fingerprint recognition area under the screen.

In order to overcome the above technical problem, the following technical solutions are adopted by an embodiment of the application.

A fingerprint operation prompting method includes: detecting whether a display device receives a fingerprint recognition instruction; dynamically displaying the first image for prompting the fingerprint operation in the preset target area when the fingerprint recognition instruction implemented for the display device is detected; wherein the preset target area is located in the display area of the display device.

Optionally, dynamically displaying the first image for prompting the fingerprint operation in the preset target area specifically includes: controlling the illuminating sub-pixels in the preset target area to dynamically display a first image for prompting the fingerprint operation according to the preset display rule.

Optionally, the first image is a static graphic; the controlling the illuminating sub-pixels in the preset target area to dynamically display a first image for prompting the fingerprint operation according to the preset display rule, specifically including: controlling to illuminate the illuminating sub-pixels for displaying the static graphics in the preset target area; periodically updating the static graphics to alternately display different grayscales.

Optionally, the first image is circular or annular.

Optionally, the first image is a dynamic graphic; the controlling the illuminating sub-pixels in the preset target area to dynamically display a first image for prompting the fingerprint operation according to the preset display rule, specifically including: determining a plurality of sub-areas defined in the preset target area and all image frames of the dynamic graphic, each of the sub-areas corresponding to a corresponding number of illuminating sub-pixels; controlling to illuminate the illuminating sub-pixels for displaying any of the image frames of the dynamic graphics in the preset target area; sequentially updating and illuminating the illuminating sub-pixels for displaying the next image frame according to the display order of all the image frames of the dynamic graphic.

Optionally, the first image is an alternately changing lattice pattern or an annular pattern.

Optionally, the first image includes at least one movable picture; the controlling the illuminating sub-pixels in the preset target area to dynamically display a first image for prompting the fingerprint operation according to the preset display rule, specifically including: sequentially controlling to illuminate the corresponding illuminating sub-pixels in the corresponding interface of the preset target area according to a direction and a speed of the at least one movable picture into the preset target area; the at least one movable picture moves in from any side of the preset target areas and moves out from a side opposite to the side of moving-in.

Optionally, the first image is a movable picture input through an operating system of the display device or a movable picture generated by a driver chip using an algorithm.

Optionally, the method further includes: ending the display when it is detected that the duration of dynamically displaying the first image for prompting the fingerprint operation in the preset target area exceeds a preset threshold.

A display panel includes a detecting module configured to detect whether the display device receives a fingerprint recognition instruction; and a display module configured to dynamically display a first image for prompting a fingerprint operation in a preset target area when the fingerprint recognition instruction implemented for the display device is detected; wherein the preset target area is located within the display area on the display device.

Optionally, when the display module dynamically displays the first image for prompting the fingerprint operation in the preset target area, the display module is specifically configured to: control the illuminating sub-pixels in the preset target area to dynamically display the first image for prompting the fingerprint operation according to the preset display rule.

Optionally, the first image is a static graphic.

Optionally, the first image is circular or annular.

Optionally, the first image is a dynamic graphic.

Optionally, the first image is an alternating lattice pattern or an annular pattern.

Optionally, the first image includes at least one movable picture.

A display device including the above display panel.

The following beneficial effects can be achieved by the at least one of the above-mentioned technical solutions adopted in the embodiment of the application.

By means of the display manner of breathing lamp or the horse race lamp, a fingerprint prompting LOGO for prompting the user is displayed dynamically in the preset target area. Such display mode can avoid the problem of the ghost shadow caused by the illuminating sub-pixels in the preset target area always displaying the static images. Moreover, the dynamic display manner of the application does not make the illuminating sub-pixels to display one grayscale for a long time, thereby reducing the illuminating time of the illuminating sub-pixel to a certain extent and alleviating the aging problem of the illuminating sub-pixels.

### BRIEF DESCRIPTION OF THE DRAWINGS

The drawings described herein are intended to provide a further understanding of the application, and are intended to be a part of this application. The illustrative embodiments of the application and the description thereof are intended for explaining the application and do not constitute an undue limitation to the application. In the drawings:

FIG. 1 is a schematic view of steps of a method for prompting a fingerprint operation according to an embodiment of the application;

FIG. 2(a) is a first dynamic display mode of the preset target area in the embodiment of the application;

FIG. 2(b) is a second dynamic display mode of the preset target area in the embodiment of the application;

FIG. 3(a) is a third dynamic display mode of the preset target area in the embodiment of the application;

FIG. 3(b) is a fourth dynamic display mode of the preset target area in the embodiment of the application;

FIG. 4 (a) is a fifth dynamic display mode of the preset target area in the embodiment of the application;

FIG. 4(b) is a sixth dynamic display mode of a preset target area in the embodiment of the application; and

FIG. 5 is a schematic view of a module of a display panel according to the application.

### DETAILED DESCRIPTION

In order to make the objects, the technical solution and the advantages of the application clearer, the technical solution of the application will be clearly and completely described in the following with reference to the specific embodiments of the application and the corresponding drawings. It is apparent that the described embodiments are only a part of the embodiments of the application rather than all of them. All other embodiments obtained by a person skilled in the art based on the embodiments of the application without paying creative work fall into the protection scope of the application.

The technical solution provided by the embodiments of the application is described in detail below with reference to the accompanying drawings.

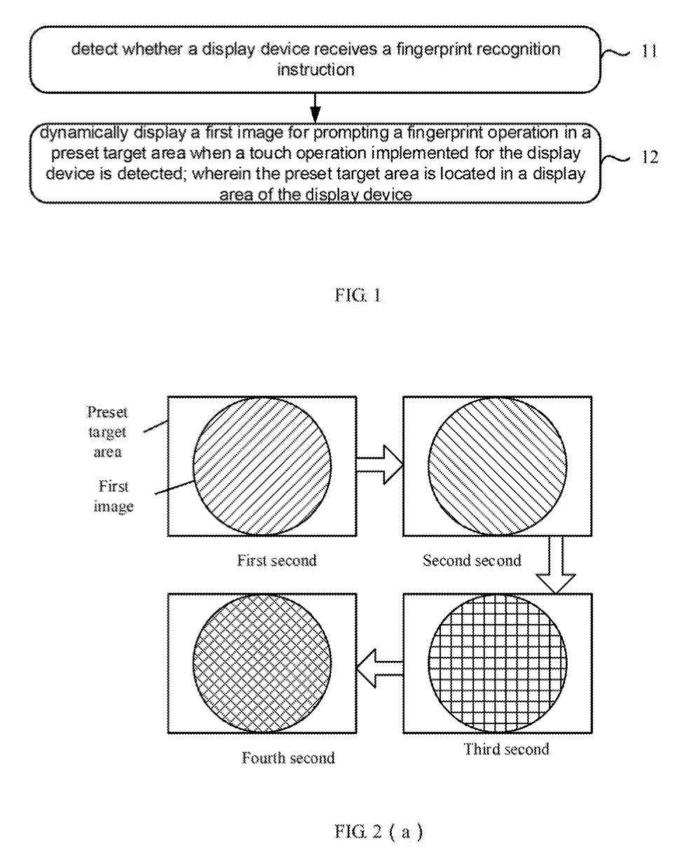

FIG. 1 is a schematic view of steps of a method for prompting a fingerprint operation according to an embodiment of the application, wherein the method mainly includes the following steps.

Step 11: detect whether a display device receives a fingerprint recognition instruction.

In the application, a touch sensor can be provided in the display device for real-time monitoring whether the display device receives the fingerprint recognition instruction. The display device herein refers to a display device provided with a fingerprint recognition module under screen, and may be, for example, a full-screen mobile phone or a tablet computer. The fingerprint recognition instruction may be triggered by a touch operation, or may be triggered by a voice control or an instruction sent by another terminal devices, and the touch operation may be any form of touch operation implemented for the display device; for example, a touch operation may be any one of the following operations: picking up the display device, pressing the screen or the button of the display device with single-finger or multi-finger, rotating the display device, and shaking the display device.

Step 12: dynamically display a first image for prompting a fingerprint operation in a preset target area when a touch operation implemented for the display device is detected; wherein the preset target area is located in a display area of the display device.

In the application, the first image for prompting the fingerprint operation is displayed in the preset target area only when the touch operation implemented for the display device is detected, so that there is no need for the first image to be displayed in the preset target area all the time, thus saving power consumption; Moreover, the first image is dynamically displayed in the preset target area, avoiding a ghost shadow of the image caused by the static display, thereby ensuring the quality of the display image.

Optionally, in the application, the step 12 may specifically includes: controlling the illuminating sub-pixel in the preset target area to dynamically display the first image for prompting the fingerprint operation according to a preset display rule. The first image involved may be set when the display device is manufactured, or may be selected by an application according to the user's selection, and used as the fingerprint LOGO. This application does not limit this.

It should be noted that the preset display rule is related to the type of the first image; when the first image is a static graphic, the preset display rule may be: the static graphic of the first image is unchanged, and the grayscale is alternated; when the first image is a dynamic graphic, the preset display rule may be: the dynamic graphic of the first image changes, and/or the grayscale also changes; when the first image is a movable picture, the preset display rule may be: the movable picture in the first image moves in from one side of the preset target area, and moves out from the opposite side.

Three dynamic display solutions involved in the application are described below.

The First Image is a Static Graphic

In the application, the controlling the illuminating sub-pixel in the preset target area to dynamically display the first image for prompting the fingerprint operation according to the preset display rule, specifically includes: controlling to illuminate the illuminating sub-pixel in the preset target area for displaying the static graphic, periodically updating the static graphic to alternately display different colors. In fact, in a specific implementation, the system determines the illuminating sub-pixels need to be illuminated according to the contour of the static graphic, and controls the illuminating sub-pixels to illuminate so as to display the static graphic; meanwhile, the grayscale of the static graphic is updated according to a preset period, thus the static graphic is alternately displayed with different colors.

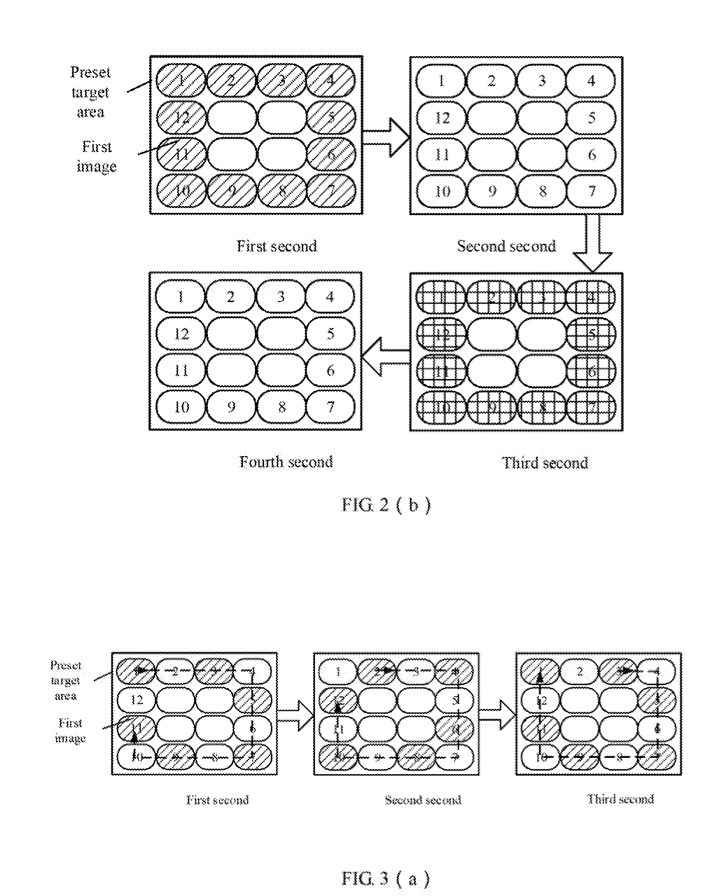

Specifically, referring to FIG. 2(a), the area defined by the block is a preset target area of the display area in the display device, and the first image is a circular pattern; assuming that the first image updates one color every 1 s, and updates four times per cycle, then there can be the following cases:

When the illuminating sub-pixels are displayed at 1 s, the illuminating sub-pixels in the circular pattern area are all set to 255, 0, 0; the circular pattern shows red, and the left diagonal stripe in FIG. 2(a) indicates that the displayed color is red;

When the first image is displayed at 2 s, the illuminating sub-pixels in the circular pattern area are all set to 0, 255, 0; the circular pattern shows green, and the right diagonal stripe in FIG. 2(a) indicates that the displayed color is green;

When the first image is displayed at 3 s, the illuminating sub-pixels in the circular pattern area are all set to 0, 0, 255; the circular pattern shows blue, and the square in FIG. 2(a) indicates that the displayed color is blue;

When the first image is displayed at 4 s, the illuminating sub-pixels in the circular pattern area are all set to 255, 255, 0; the circular pattern shows yellow, and the oblique grid in FIG. 2(a) indicates that the displayed color is yellow; thus the displayed color of the circular pattern is updated in a cycle alternating manner. In fact, any one of the colors can also be displayed at 1 s; no color is displayed at 2 s, then any one of the colors is displayed at 3 s, and no color is displayed at 4 s, thus, a fingerprint prompting LOGO for prompting the location of fingerprint area to user can be formed in a way of breathing lamp.

For example, as shown in FIG. 2(b), the area defined by the block is a preset target area of the display area in the display device, and the first image is a annular pattern, that is, it can be understood as illuminating sub-pixels corresponding to the block area are equally divided into 16 parts, where the illuminating sub-pixel 1 to illuminating sub-pixel 12 located in the edge area of the block correspondingly display a annular pattern; then, the illuminating sub-pixel 1 to illuminating sub-pixel 12 can alternately display different colors according to the manner of FIG. 2(a), or the illuminating sub-pixels can also display the color once every 1 s:

When the first image is displayed at 1 s, the illuminating sub-pixels in the annular pattern area are all set to 255, 0, 0; the annular pattern shows red, and the left oblique stripe in FIG. 2(b) indicates that the displayed color is red;

When the first image is displayed at 2 s, the illuminating sub-pixels in the annular pattern area are turned off and nothing is displayed;

When the first image is displayed at 3 s, the illuminating sub-pixels in the annular pattern area are all set to 0, 0, 255; the annular pattern shows blue, and the square in FIG. 2(b) indicates that the displayed color is blue;

When the first image is displayed at 4 s, the illuminating sub-pixels in the annular pattern area are turned off and nothing is displayed; thus, the illuminating sub-pixels of the annular pattern are turned on or off in a cycle alternating way, and the color of the illuminating sub-pixels may be unchanged or may be alternately updated when turned on. Thus, a fingerprint prompting LOGO for prompting the location of the fingerprint area to user can be formed in a way of breathing lamp.

The First Image is a Dynamic Graphic

In the application, the controlling the illuminating sub-pixel in the preset target area to dynamically display the first image for prompting the fingerprint operation according to a preset display rule, specifically includes: determining a plurality of sub-areas defined in the preset target area and all the image frames of the dynamic graphics, each of the sub-areas corresponding to a corresponding number of illuminating sub-pixels; controlling to illuminate the illuminating sub-pixels of any of the image frames for displaying the dynamic graphics in the preset target area; sequentially updating and illuminating the illuminating sub-pixels for displaying the next image frame of the graphic according to a displayed order of all the image frames of the dynamic graphics.

The image frame of the graphic refers to the graphic displayed in each frame, and there may be a plurality of the same image frames in the application. When displaying, only different image frames may be selected. For the plurality of selected image frames, each of the image frames is alternately displayed according to a certain period.

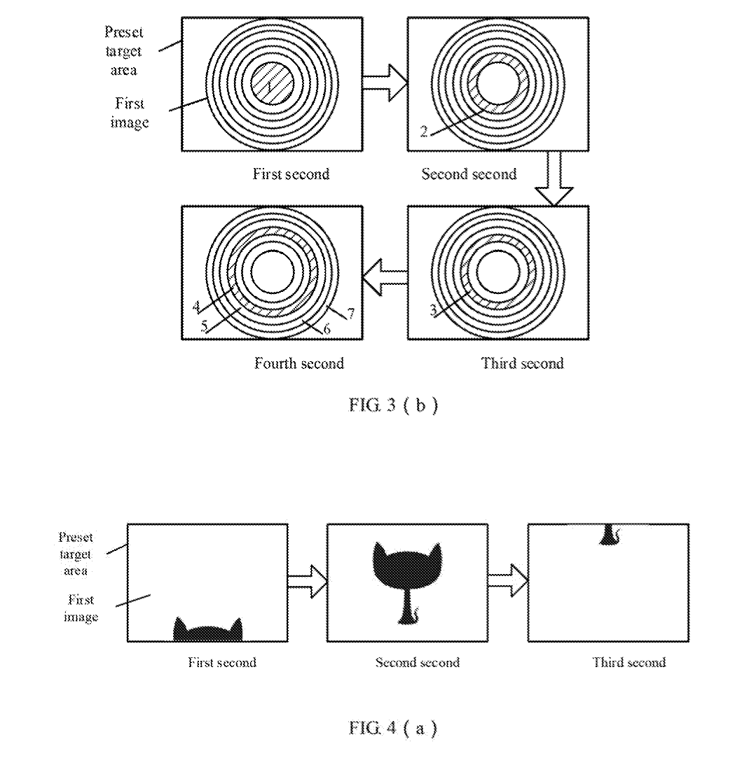

Specifically, referring to FIG. 3(a), the area defined by the block is a preset target area of the display area in the display device, and the first image is an alternately changing lattice pattern, that is, it can be understood as illuminating sub-pixels corresponding to the block area are equally divided into 16 parts, wherein the illuminating sub-pixel 1 to illuminating sub-pixel 12 located in the edge area of the block correspondingly display an alternating changed lattice pattern; then, the illuminating sub-pixel 1 to illuminating sub-pixel 12 can alternately display different image frames according to the manner of FIG. 3(a). Still take the alternating time being 1 s as an example:

When the first image is displayed at 1 s, the grayscale of the illuminating sub-pixel 1, the illuminating sub-pixel 3, the illuminating sub-pixel 5, the illuminating sub-pixel 7, the illuminating sub-pixel 9, and the illuminating sub-pixel 11 is sequentially set to 255, and the other illuminating sub-pixels are in a turned off state, that is, the grayscale is set to 0:

When the first image is displayed at 2 s, the grayscale of the illuminating sub-pixel 2, the illuminating sub-pixel 4, the illuminating sub-pixel 6, the illuminating sub-pixel 8, the illuminating sub-pixel 10, and the illuminating sub-pixel 12 are sequentially set to 255, and the other illuminating sub-pixels are turned off, that is, the grayscale is set to 0;

When the first image is displayed at 3 s, the grayscale of the illuminating sub-pixel 3, the illuminating sub-pixel 5, the illuminating sub-pixel 7, the illuminating sub-pixel 9, the illuminating sub-pixel 11, and the illuminating sub-pixel 1 is sequentially set to 255, and the other illuminating sub-pixels are turned off, that is, the grayscale is set to 0. Thus a fingerprint prompting LOGO can be formed in a way of breathing lamp and a horse race lamp by the recycling of the above process.

For example, as shown in FIG. 3(b), the area defined by the block is a preset target area of the display area in the display device, and the first image is an alternately changing annular pattern, that is, it can be understood as the illuminating sub-pixels corresponding to a circular pattern in the block area are equally divided into seven parts, wherein the circular pattern from the center to the edge is divided into seven illuminating sub-pixels corresponding to the annular patterns with different sizes, i.e., the illuminating sub-pixel 1 to the illuminating sub-pixel 7. Then, the illuminating sub-pixel 1 to the illuminating sub-pixel 7 can sequentially display annular patterns of different sizes from the center to the edge according to the manner shown in FIG. 3(b), and still take the alternating time being 1 s as an example:

When the annular patterns are displayed at 1 s, the grayscale of the illuminating sub-pixel 1 is set to 255, and the other illuminating sub-pixels are in a turned off state, that is, the grayscale is set to 0;

When the annular patterns are displayed at 2 s, the grayscale of the illuminating sub-pixel 2 is set to 255, and the other illuminating sub-pixels are in a turned off state, that is, the grayscale is set to 0;

When the annular patterns are displayed at 3 s, the grayscale of the illuminating sub-pixel 3 is set to 255, and the other illuminating sub-pixels are in a turned off state, that is, the grayscale is set to 0;

When the annular patterns are displayed at 4 s, the grayscale of the illuminating sub-pixel 4 is set to 255, and the other illuminating sub-pixels are in a turned off state, that is, the grayscale is set to 0. Thus a fingerprint prompting LOGO can be formed in a way of breathing lamp and a horse race lamp by the recycling of the above process.

In fact, each time different annular pattern is alternately displayed, the colors can be updated simultaneously to form a colorful effect.

The first image is a movable picture.

The first image may include at least one movable picture. In the application, the controlling the illuminating sub-pixel in the preset target area to dynamically display the first image for prompting the fingerprint operation according to a preset display rule, specifically includes: according to a direction and a speed of the at least one movable picture entering into the preset target area, sequentially controlling to illuminate the corresponding illuminating sub-pixels in the corresponding interface of the preset target area. The at least one movable picture moves in from any side of the preset target areas and moves out from a side opposite to the side of moving-in. Although the first image relates to the movement of the picture, it is essentially a dynamic display by means of controlling the illumination of the illuminating sub-pixel.

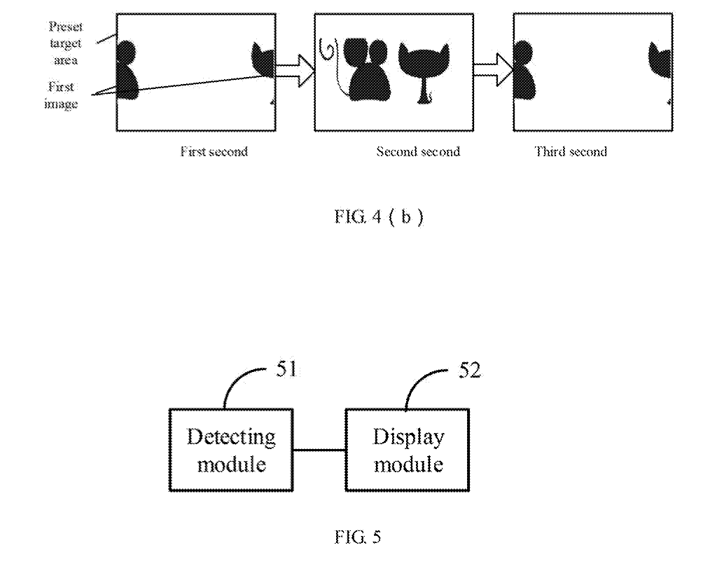

Specifically, referring to FIG. 4(a), the area defined by the block is a preset target area of the display area in the display device, and the first image is a static or dynamic picture, and the picture may follow a predetermined movement rule: moving in from the bottom of the preset target area, passing through the preset target area and moving out from the top of the preset target area, thereby forming a dynamically displayable fingerprint prompting LOGO. In fact, the picture can also move in from the left side and move out from the right side.

As shown in FIG. 4(b), there may be two movable pictures. According to a predetermined movement rule, one movable picture moves in from the left side of the preset target area, and the other movable picture moves in from the right side of the preset target area, the moving speeds of the two movable pictures are the same, and after meeting, the two movable pictures respectively return and move out from their moving-in side respectively, thereby forming a dynamically displayable fingerprint prompting LOGO. In fact, in the application, after the two movable pictures meet, they can continue to advance, overlap and display, and move out from the moving-in side of the other one. In addition, it is also possible to select to move in or out at other angles, which is not limited in the application.

It should be noted that the division manner and the alternate updating time of the illuminating sub-pixels mentioned above may be flexibly set according to the setting of the system or according to the needs of the user.

It can be known from the above technical solution that the fingerprint prompting LOGO for prompting the user is dynamically displayed in the preset target area by means of the display manner of the breathing lamp or the horse race lamp. Such a display manner can prevent the problem of ghost shadow caused by the illuminating sub-pixel of the preset target area displaying the static image all the time. The dynamic display manner of the application makes the illuminating sub-pixel not display one grayscale for a long time, thereby reducing the illuminating time length of the illuminating sub-pixel to a certain extent, and alleviating the problem of aging of the illuminating sub-pixel.

Optionally, in the application, when the first image is a movable picture, the first image is a movable picture input through an operating system of the display device or a movable picture generated by a driving chip using an algorithm, which is not limited in the application.

Optionally, in the application, after the first image is dynamically displayed in the preset target area, the user may perform fingerprint recognition in the preset target area according to the prompted image. However, the preset target area does not always display the first image dynamically. Then, in order to save battery power consumption and alleviate aging of the illuminating sub-pixel, the method further includes: ending the display when the duration of dynamically displaying the first image for prompting the fingerprint operation in the preset target area exceeding a preset threshold are detected that. In the specific implementation, taking the mobile phone up may be used as a condition for triggering the dynamic display of the prompted image; when the duration of dynamically displaying the first image for prompting the fingerprint recognition position exceeds for more than 20 s, and the fingerprint recognition operation is still not performed in the preset target area, then the first image will disappear, that is, displaying the first image will end. When the fingerprint recognition is anticipated to be performed again, the dynamic display of the prompted image can be triggered by another triggering condition other than picking up the mobile phone.

Referring to FIG. 5, FIG. 5 is a schematic view showing a module of a display panel provided by the application. The display panel mainly includes: a detecting module 51 configured to detect whether the display device is subjected to a touch operation; a display module 52 configured to dynamically display a first image for prompting a fingerprint operation in a preset target area when a touch operation implemented for the display device is detected; the preset target area is located within the display area on the display device.

Optionally, when the display module 52 dynamically displays the first image for prompting the fingerprint operation in the preset target area, the display module 52 is specifically configured to: control the illuminating sub-pixels in the preset target area to dynamically display the first image for prompting the fingerprint operation in the preset target area according to the preset display rule.

It can be known from the above technical solution that, the display module controls the illuminating sub-pixels in the preset target area, and dynamically displays the fingerprint prompting LOGO for prompting the user by means of the manner of breathing lamp or the horse race lamp etc., thereby avoiding the problem of the ghost shadow caused by the illuminating sub-pixels always displaying the static images in the preset target area. Moreover, the dynamic display manner of the application does not make the illuminating sub-pixels to display a grayscale for a long time, thereby reducing the illuminating time of the illuminating sub-pixels to a certain extent and alleviating the aging problem of the illuminating sub-pixels.

Meanwhile, the application also proposes a display device including the display panel. In addition, the display device can be any product or component with a display function, such as a mobile phone, a tablet computer, a television, a display, a notebook computer, a digital photo frame, a navigator, a smart wearable device, and the like. Other indispensable components of the display device are possessed as understood by a person skilled in the art, and are not described herein, nor should be construed as a limitation to the application.

The above description is only an embodiment of the application and is not intended to limit the application. Various changes and modifications can be made to the application by a person skilled in the art. Any modifications, equivalents, improvements, etc. made within the spirit and principles of the application are intended to fall into the scope of the appended claims.

What is claimed is:

1. A fingerprint operation prompting method, comprising:
detecting whether a display device receives a fingerprint recognition instruction; and
dynamically displaying a first image for prompting a fingerprint operation in a preset target area when the fingerprint recognition instruction implemented for the display device is detected, the preset target area being located in a display area of the display device.

2. The fingerprint operation prompting method of claim 1, wherein the dynamically displaying the first image for prompting the fingerprint operation in the preset target area specifically comprises:
controlling illuminating sub-pixels in the preset target area to dynamically display the first image for prompting the fingerprint operation according to a preset display rule.

3. The fingerprint operation prompting method of claim 2, wherein the first image is a static graphic;
the controlling the illuminating sub-pixels in the preset target area to dynamically display the first image for prompting the fingerprint operation according to the preset display rule, comprising:
controlling to illuminate the illuminating sub-pixels for displaying static graphics in the preset target area; and
periodically updating the static graphics to alternately display different grayscales.

4. The fingerprint operation prompting method of claim 3, wherein the first image is circular or annular.

5. The fingerprint operation prompting method of claim 2, wherein the first image is a dynamic graphic;
the controlling the illuminating sub-pixels in the preset target area to dynamically display the first image for prompting the fingerprint operation according to the preset display rule, specifically comprising:
determining a plurality of sub-areas defined in the preset target area and all image frames of the dynamic graphic, each of the sub-areas corresponding to a corresponding number of illuminating sub-pixels;
controlling to illuminate the illuminating sub-pixels for displaying any of the image frames of the dynamic graphic in the preset target area; and
sequentially updating and illuminating the illuminating sub-pixels for displaying a next image frame according to a display order of all the image frames of the dynamic graphic.

6. The fingerprint operation prompting method of claim 5, wherein the first image is of an alternately changing lattice pattern or an annular pattern.

7. The fingerprint operation prompting method of claim 2, wherein the first image comprises at least one movable picture;
the controlling the illuminating sub-pixels in the preset target area to dynamically display the first image for prompting the fingerprint operation according to the preset display rule, specifically comprising:
according to a direction and a speed of the at least one movable picture entering into the preset target area, sequentially controlling to illuminate corresponding illuminating sub-pixels in corresponding interface of the preset target area; the at least one movable picture moves in from any side of the preset target area and moves out from a side opposite to the side of moving-in.

8. The fingerprint operation prompting method of claim 7, wherein the first image is a movable picture input through an operating system of the display device or a movable picture generated by a driver chip using an algorithm.

9. The fingerprint operation prompting method of claim 1, wherein the method further comprises:
ending the display when a duration of dynamically displaying the first image for prompting the fingerprint operation in the preset target exceeding a preset threshold are detected.

10. A display panel comprising:
a detecting element configured to detect whether a display device receives a fingerprint recognition instruction; and
a display element configured to dynamically display a first image for prompting a fingerprint operation in a preset target area when the fingerprint recognition instruction implemented for the display device is detected; wherein the preset target area is located within a display area on the display device.

11. The display panel of claim 10, when the display module dynamically displays the first image for prompting the fingerprint operation in the preset target area, the display module is specifically configured to:
control illuminating sub-pixels in the preset target area to dynamically display the first image for prompting the fingerprint operation according to a preset display rule.

12. The display panel of claim 11, wherein the first image is a static graphic.

13. The display panel of claim 12, wherein the first image is circular or annular.

14. The display panel of claim 11, wherein the first image is a dynamic graphic.

15. The display panel of claim 14, wherein the first image is an alternating lattice pattern or an annular pattern.

16. The display panel of claim 11, wherein the first image comprises at least one movable picture.

17. A display device comprising a display panel of claim 10.
